(19) United States
(12) Patent Application Publication
(10) Pub. No.: US 2014/0165561 A1
(43) Pub. Date: Jun. 19, 2014

(54) Supercharger Turbocharger Bypass Back Draft Inlet Damper for Series Operation

(71) Applicant: Klint M. KINGSBURY, Austin, TX (US)

(72) Inventor: Klint M. KINGSBURY, Austin, TX (US)

(21) Appl. No.: 14/014,295

(22) Filed: Aug. 29, 2013

Related U.S. Application Data
(60) Provisional application No. 61/694,542, filed on Aug. 29, 2012.

(51) Int. Cl. F02B 37/10

(52) U.S. Cl. CPC F02B 37/10
USPC 60/612

(57) ABSTRACT

A damper system for placement between a supercharger and a turbocharger. The damper is located in a plenum placed within the air path from the supercharger to the turbocharger. If the plenum is under positive pressure from the supercharger, the damper seals shut against the plenum, allowing the supercharger to build positive boost pressure to the turbocharger. The damper is designed to stay closed until the plenum experiences a slightly negative pressure. The damper then opens to expose the turbocharger inlet to atmospheric pressure. This allows the turbocharger to intake the airflow from the smaller supercharger, but also to intake additional airflow from the ambient air at atmospheric pressure. The damper allows an engine to take advantage of the low RPM and low load performance and efficiency of smaller superchargers and the performance and efficiency of larger turbochargers under higher load and higher exhaust mass flow rate.

### CROSS REFERENCES TO RELATED APPLICATIONS

This application claims the benefit under Title 35 United States Code §119(e) of U.S. Provisional Patent Application Ser. No.: 61/694,542; filed: Aug. 29, 2012, the full disclosure of which is incorporated herein by reference.

### BACKGROUND OF THE INVENTION

1. Field of the Invention

The present invention relates generally to internal combustion engines and accessories for improving engine efficiencies. The present invention relates more specifically to engine turbochargers and superchargers, and to air flow structures for improving their performance through a range of engine operating speeds (RPMs).

2. Description of the Related Art

Internal combustion engines operate by drawing or injecting an air/fuel mixture into the combustion cylinders of the engine. The air to fuel ratio in the mixture is critical to the efficient operation of the engine. While fuel can typically be drawn into the mixture at any rate, it is sometimes difficult to draw air into the mixture at a high enough rate to produce an optimal air/fuel mixture ratio. Turbochargers and superchargers are used to increase the flow of air into the air/fuel mixture and thereby improve engine performance. Although similar in purpose, a turbocharger typically derives its power from the flow of exhaust gases from the engine, while a supercharger typically derives its power from a mechanical linkage to the rotating engine. In most applications, turbochargers operate most efficiently at higher RPMs while superchargers operate most efficiently at lower RPMs. Systems that combine the two can potentially gain the benefit of each across a range of engine loads and speeds.

On a gasoline or diesel engine, when operating a supercharger in series with a turbocharger, it is advantageous to have a small supercharger as compared to the turbocharger. The small supercharger builds lower pressure boost very quickly for maximum low load and low engine speed (revolutions per minute or RPM) performance and efficiency. The turbocharger on the other hand, is typically sized to build high boost pressure for maximum high load and high RPM performance. The problem in a series configuration is that if the size differential between the supercharger and the turbocharger is too great, the supercharger will impede the performance of the turbocharger. As the turbocharger begins to draw higher air flow rates (cubic feet per minute or CFM) through the supercharger, the smaller supercharger begins to greatly impede the air flow and can even cause cavitations in the turbocharger.

The supercharger speed is directly dependent on the engine RPM (typically connected through a mechanical linkage such as to a camshaft or a drive belt or chain) and cannot spin faster or produce more airflow than allowed by engine RPM. So if sized too small, the supercharger acts as a major hindrance on the turbocharger, which is dependent on exhaust mass flow rate (typically connected through turbine blades within the engine exhaust flow) and can continue to accelerate under load. For this reason, the supercharger and the turbocharger, if operating in series, must be designed for similar airflows and boost pressures. This aids in high load and high RPM performance, but the low load and low RPM performance and efficiency will often suffer.

As stated above, on a gasoline or diesel engine, when operating a supercharger in series with a turbocharger, it is advantageous to have a smaller supercharger relative to the size and output of the turbocharger. The small supercharger builds lower pressure boost very quickly for maximum low load and low RPM performance and efficiency. The larger turbocharger, on the other hand, builds higher boost pressure for maximum high load and high RPM performance. Unfortunately, if the size differential between the supercharger and the turbocharger is too great, the supercharger will impede the performance of the turbocharger. As the turbocharger begins to draw higher CFM levels through the supercharger, the smaller supercharger cannot keep up with the higher flow rates and begins to hold back the air flow, a condition that can cause cavitations in the spinning turbine blades of the turbocharger. This occurs because the supercharger speed is directly dependent on the engine RPM and cannot spin faster or produce more airflow than allowed by engine RPM. So if sized too small, it acts as a major hindrance on the turbocharger, which is dependent on exhaust mass flow rate, can continue to accelerate under load, and can even be slowed by ducting off some portion of the exhaust flow. Once again therefore, a supercharger and a turbocharger, if operating in series, must be able to adapt to a common air flow rate and to produce a common boost pressure. The present invention is directed to solving the problem of matching air flow rates and boost pressures in the series operation of a turbocharger and supercharger.

The claimed invention differs from what currently exists. In parallel operation, dampers and air valves have been used to combine the low RPM performance of superchargers with the high RPM performance of turbochargers. In series operation, they are combined based on similar size and airflow, and are not used with a back draft inlet damper. In series operation a small supercharger would traditionally impede the performance of a larger turbocharger. In contrast, with parallel operation, a smaller supercharger is frequently used in conjunction with a larger turbocharger. The use of dampers and/or valves is necessary in parallel combinations of superchargers and turbochargers, along with the associated electronic controls and electronic actuators. These systems monitor the inlet pressure of the engine intake and modulate dampers to control the efficiency of the airflows as between the supercharger and the turbocharger into the intake. Such systems are typically very expensive, complicated, and not very durable. The proposed invention eliminates the need for complex controls, while allowing for a small supercharger to improve low RPM performance and efficiency, without hindering the operation of a larger turbocharger for higher RPM performance. In a diesel engine, the system of the present invention will also help to eliminate the turbo-lag commonly found in turbo-diesel engines. The proposed invention is simple with only one moving part and no electronics.

### SUMMARY OF THE INVENTION

The present invention provides a damper located between a supercharger and a turbocharger. The damper is located in a plenum placed within the air path from the supercharger to the turbocharger. The damper is only slightly forced close in its natural position. This force can be generated by a spring or by gravity, depending on design and location of the damper. If the plenum is under positive pressure from the supercharger, the damper seals shut against the plenum, allowing the supercharger to build positive boost pressure to the turbocharger. The spring or gravity force on the damper is designed to keep the damper closed until the plenum experiences a slightly “negative” pressure (a lower than atmospheric pressure). The damper then opens due to the pressure differential and exposes the turbocharger inlet to atmospheric pressure. This allows the turbocharger to intake the airflow from the smaller supercharger, but also to intake additional airflow from the ambient air at atmospheric pressure.

The opening of the damper prevents the turbocharger performance and efficiency from being hindered by negative inlet pressure and additional drag from the smaller supercharger. The damper allows an engine to take advantage of the low RPM and low load performance and efficiency of a smaller supercharger and also utilize the performance and efficiency of a larger turbocharger under higher load and higher exhaust mass flow rate. Along with the dramatic low end performance and efficiency, the simplicity of the pressure operating damper also eliminates the complexity and cost of controllers and electronic damper actuators.

### BRIEF DESCRIPTION OF THE DRAWINGS

FIG. 1 is a perspective view of the damper system of the present invention shown with one wall of the plenum removed to show the internal components of the system.

FIG. 2 is a detailed perspective view of the damper valve positioned through a wall of the plenum, shown in an open configuration allowing ambient air to flow into the system.

FIG. 3 is a schematic block diagram of one implementation of the damper system of the present invention, showing its general placement between a turbocharger and a supercharger connected in series to an internal combustion engine.

### DETAILED DESCRIPTION OF THE PREFERRED EMBODIMENS

The structures of the present invention are shown in the appended Drawing figures with the following identified components and connections.

Damper Assembly—The damper assembly 18 is located inside the housing 12. The damper assembly 18 is designed to seal against an opening in the wall of the housing 12 when the housing 12 is under any slightly positive pressure. The components of damper assembly 18 should be constructed of a lightweight, but rigid material such as, but not limited to, aluminum. The valve door 30 component of the damper assembly 18 should have some type of coating to make an air seal against the housing 12. This gasket-like coating can also be on the housing 12. The damper assembly 18 must be designed to open easily under slight negative pressure but be durable to withstand continuous opening and closing as well as the maximum negative pressure generated by the turbocharger. The valve door 30 of damper assembly 18 is secured to the housing with damper mount 26. The damper assembly 18 requires either gravity force to keep it closed, or in the preferred embodiment, a torsional force provided by spring 36.

Damper Mount—The damper mount 26 should be rigid and wear resistant to the continuous opening and closing of the valve door 30. The damper mount 26 is preferably constructed of, but not limited to, aluminum. The addition of a bearing (not shown) to the damper mount 26 is also preferred.

Supercharger Discharge Tube—The supercharger discharge tube 14 connects the smaller supercharger to the plenum housing 12. By extending some distance into the plenum it also guides the air flow through the plenum and prevents turbulence in the plenum. This supercharger discharge tube 14 can be of aluminum, any of a number of other metals, or a polymer or composite material.

Turbocharger Intake Tube—The turbocharger intake tube 16 connects the plenum housing 12 to the turbocharger. This turbocharger intake tube 16 can be of aluminum, any of a number of other metals, or a polymer or composite material.

Plenum Housing—The pressure in the plenum housing 12 changes as the airflow out of the housing 12 through the turbocharger intake tube 16 increases beyond the amount of airflow coming through the supercharger discharge tube 14. As the turbocharger starts to overcome the much smaller supercharger, the airflow differential generates a negative pressure within the housing 12 and the damper assembly 18 opens. This allows the turbocharger to generate unimpeded filtered airflow by drawing additional air through a filter (not shown) positioned in the air filter rack 24 and in through the damper opening 40. The housing 12 should be constructed of a lightweight but rigid material such as but not limited to aluminum, a polymer material, or a composite material.

Air Filter Rack—The air filter rack 24 holds a filter to filter the air coming in through the damper opening 40. The rack can be constructed of aluminum, other metal, a polymer material, or a composite material.

Pivot Bolt—The pivot bolt 34 connects the valve door 30, positioned on the valve door arm 32, to the damper mount hinge 38.

Closer Spring—The damper assembly 18 requires either gravity force to keep it closed, or in the preferred embodiment, a torsional force provided by closure spring 36. The spring 36 can be placed around the bolt 34 that holds the valve door arm 32 to the damper mount hinge 38. The spring 36 should be sized such that when the pressure in the housing 12 starts to go negative, the damper assembly 18 starts to open immediately.

The damper valve door 30 is held by the damper mount 26 with a bolt, shaft or bearing. A spring 36 should contact the valve door arm 32 and either the damper mount hinge 38 or the side wall of the housing 12 in such a way that it generates a force that keeps the damper valve door 30 closed at neutral pressure. The preferred embodiment utilizes a torsional spring held on the bolt or shaft to generate a torsional force. The damper mount 26 is connected to the housing 12 either through means of bolts, welding, adhesive or other connection method.

The housing 12 is completely sealed to form a plenum. The included figures show the housing 12 without one of its sides so that the internal working components can be observed. The invention is installed between a turbocharger and a significantly smaller supercharger. The supercharger discharge tube 14 is connected and sealed to the discharge of the smaller supercharger. The supercharger discharge tube 14 is connected and sealed to the housing 12. The supercharger discharge tube 14 may be designed to direct airflow laterally past the damper assembly 18 in order to decrease turbulence and back draft inside the housing 12. Having the supercharger discharge tube 14 extend past the damper assembly 18, generates a more uniform airflow through the housing and out through the turbocharger intake tube 16. The turbocharger intake tube 16 is sealed and connected to the intake of the larger turbocharger. The supercharger discharge tube 14 can also act as a stop for the damper valve door 30 as it swings open.

The present invention is therefore an enclosure 12 with a damper assembly 18 that acts as both a back draft damper and an inlet damper into and out of a plenum located in between a small supercharger and a significantly larger turbocharger. The size ratio (supercharger to turbocharger) would be recommended as, but not limited to, a ratio in the range of 0.25:1 to 0.75:1. The housing 12 acts as the plenum and also houses the damper assembly 18.

During low RPM and low load engine operation, the supercharger is designed for maximum performance from idle up to roughly half of the engine's maximum RPM. The supercharger generates positive boost pressure into the plenum and the damper assembly 18 seals shut against the housing 12 to prevent boost pressure leakage. As the engine goes past half of its maximum RPM and runs up to maximum RPM, the supercharger should hit its upper limit and provide its maximum airflow at any point past half of the maximum engine RPM. The turbocharger should be designed for maximum performance at the maximum engine RPM.

The small supercharger allows the engine to be extremely efficient at idle and low RPM levels up to about half of the max engine RPM. As the exhaust mass flow rate of the engine starts to increase due to load and mid to high range RPM, the turbocharger will begin to draw significantly more CFM (air flow) than what the smaller supercharger can provide. At this point the pressure between the supercharger and the turbocharger within the plenum housing 12 begins to become slightly negative (below atmospheric pressure). At this point the damper assembly 18, begins to open against its torsional spring. As the pressure becomes more negative, the damper assembly 18 opens more to allow for a free unrestricted airflow into the turbocharger. Thus, the invention provides a system for extremely efficient engine operation across its entire RPM spectrum.

The Housing 10, Damper 2, Damper Mount 4, Supercharger Discharge Tube 6 and Turbocharger Intake Tube 8 can be cut or cast from aluminum or sheet steel, or molded from polymer or composite. The damper and/or the housing should be coated with a rubber or gasket type coating to allow for a good air seal. The spring and required bolts for assembly can be purchased and all of the parts assembled.

The damper assembly 18 and the plenum housing 12 are, of course, necessary elements of the present invention. The damper valve door 30 can be held in the closed position by either a spring 36 as shown in the preferred embodiment, or by gravity. The spring used to hold the damper shut does not need to be a torsional spring. Alternately, the small closure force required may be provided by part of the damper valve door arm or some other resilient part of the damper assembly. In addition, it is clear that multiple dampers could be used to seal shut under positive plenum pressure and open under negative plenum pressure in place of the single damper shown in the preferred embodiment. It is further clear that the plenum housing 12 can be constructed in many different shapes, including cylindrical or round. It is also anticipated that membranes or polymers could be used to act as the damper within this system. The damper assembly 18 may be located in different areas of the housing 12. There could be multiple dampers and different shaped plenums used to achieve the same results.

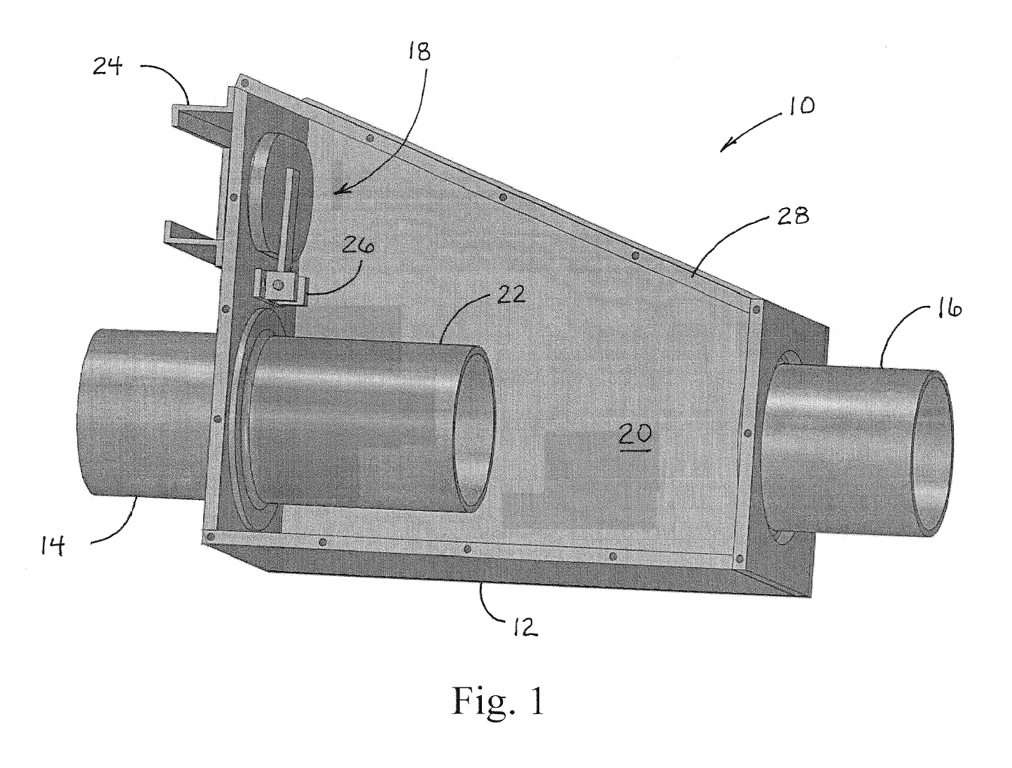

FIG. 1 is a perspective view of the damper system of the present invention shown with one wall of the plenum removed to show the internal components of the system and the interior volume 20 of the plenum. This removed wall of the plenum housing 12 would be secured to the enclosure rim 28 and would be a flat panel shaped accordingly. In this view the damper is shown in a closed condition. The air filter normally positioned with the air filter rack 24 is shown removed for clarity. A portion 22 of the supercharger discharge tube 14 extends a distance into the plenum to direct airflow laterally past the damper assembly 18.

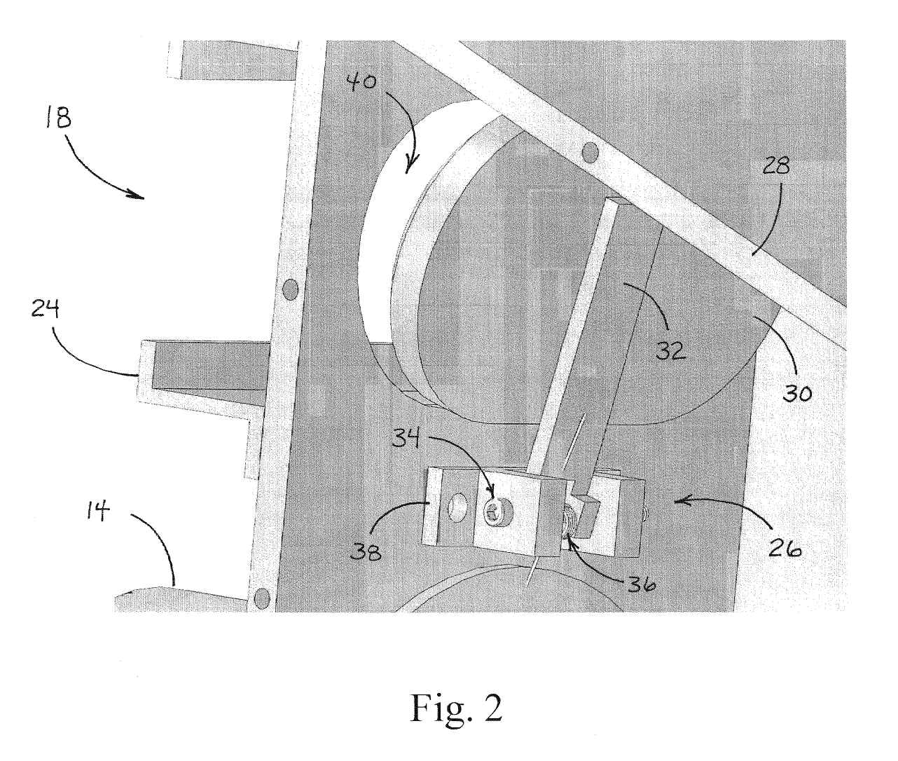

FIG. 2 is a detailed perspective view of the damper valve positioned through a wall of the plenum, shown in an open configuration allowing ambient air to drawn into the system by the slightly negative pressure within the plenum housing. Again in the view of FIG. 2, the cover wall of the housing has been removed to expose the internal components, and in particular the very few moving components of the overall system.

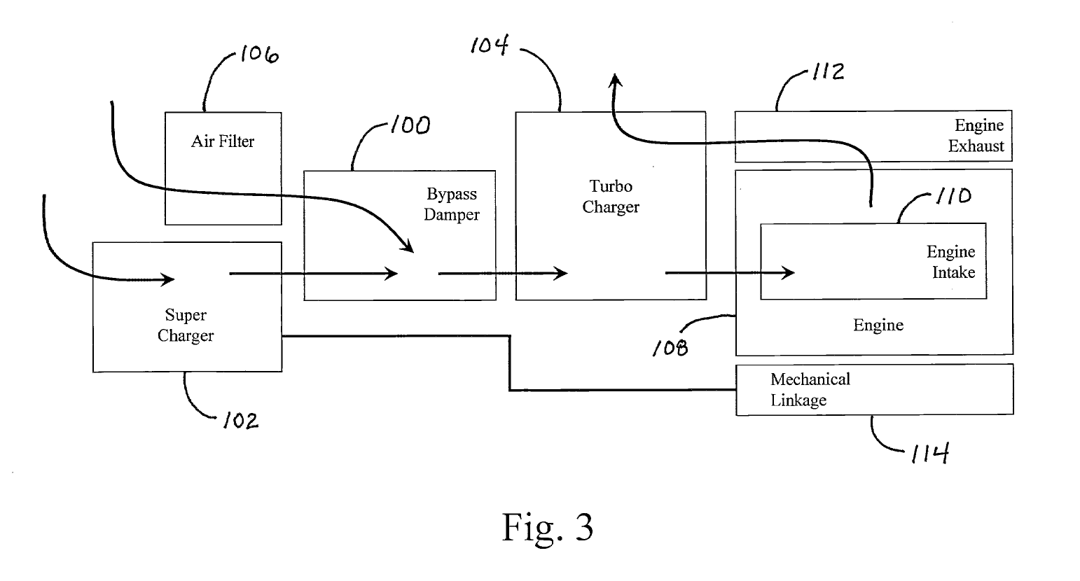

Reference is finally made to FIG. 3 which is a schematic block diagram of one implementation of the damper system of the present invention, showing its general placement between a turbocharger and a supercharger connected in series to an internal combustion engine. FIG. 3 provides a typical arrangement of system components in a series implementation of a turbocharger/supercharger combination. Bypass damper 100 of the present invention is shown installed in series between supercharger 102 and turbocharger 104. This series of components provides pressure boost and increased airflow to the intake system 110 of engine 108. Turbocharger 104 is driven by engine exhaust 112 as is typical. Supercharger 102 is driven by mechanical linkage 114 to engine 108. Air filter 106 is shown positioned to filter air drawn into the system by bypass damper 100 as described above. Of course, additional air filters normally associated with engine air intake would also be present in the overall system.

Air flow within the system shown in FIG. 3 is represented by solid arrow lines between the components. Ambient air enters the system through supercharger 102 and/or air filter 106. Exhaust from the engine 108 is directed out through engine exhaust 112, at least in part through turbocharger 104. As the system of the present invention is directed to matching air flow between a turbocharger and a supercharger, it does not alter or adversely affect the operation of any ancillary valves (bypass and the like) or intercoolers that are typically associated with such systems.

Although the geometry of the system has been shown as a basic plenum enclosure with relatively short inlet and outlet connectors, this geometry may vary according to the placement of the turbocharger and the supercharger within an engine compartment and the clearances that are available. In general, however, because these components are associated with air intake systems, there is typically available space around the engine for the placement and mounting of the device of the present invention.

The present invention has been described primarily in terms of a retrofit device that a mechanic with modest skills might install in association with aftermarket turbochargers and superchargers. The principles of the present invention, however, are equally applicable to an OEM system, especially those associated with turbo-diesel engines and the like. In such OEM embodiments, it is anticipated that the system of the present invention might be incorporated into the intake structures of the turbocharger component or the outlet structures of the supercharger component. The broad structures and operational characteristics remain the same in all of these embodiments.

I claim:

1. A damper system for operation between a supercharger and a turbocharger configured in a series to facilitate a flow of air through the turbocharger into an internal combustion engine, the damper system comprising:
a walled enclosure, the walled enclosure comprising a plurality of walls defining a generally sealed interior volume;
an inlet conduit, positioned through a first one of the plurality of walls of the walled enclosure, providing an air flow pathway into the enclosure from outside the enclosure;
an outlet conduit, positioned through a second one of the plurality of walls of the walled enclosure, providing an air flow pathway out from the enclosure to outside of the enclosure; and
a damper valve assembly positioned over an opening defined in one of the plurality of walls of the walled enclosure, the damper valve assembly movable between a closed position sealing the interior volume of the walled enclosure and an open position allowing air flow into the interior volume of the walled enclosure;
wherein the output of the supercharger is connected to the inlet conduit and the input of the turbocharger is connected to the outlet conduit.

2. The damper system of claim 1 further comprising an air filter rack configured around the opening defined in one of the plurality of walls of the walled enclosure associated with the damper valve assembly.

3. The damper system of claim 1 wherein the damper valve assembly comprises:
a valve door;
a valve door hinge, the door hinge comprising a first hinge component attached to the valve door and a second hinge component attached to an interior surface of one of the plurality of walls of the walled enclosure; and
a spring positioned on the valve door hinge so as to preference the valve door closed.
